(19) United States
(12) Patent Application Publication
(10) Pub. No.: US 2004/0178630 A1
(43) Pub. Date: Sep. 16, 2004

(54) Pipe coupling

(76) Inventor: Paul Anthony Davidson, Prestbury (GB)

Correspondence Address: Robert L Stearns, The Pinehusrt Office Center, Suite 1100, 39400 Woodward Avenue, Bloomfield Hills, MI, 48304-5151, US

(21) Appl. No.: 10/471,363

(22) PCT Filed: Mar. 14, 2002
(86) PCT No.: PCT/GB02/01160

(30) Foreign Application Priority Data
Mar. 14, 2001 (GB) 0106268.6

(51) Int. Cl. F16L 39/00

(52) U.S. Cl. 285/321

(57) ABSTRACT

An assembly having a first body including a housing for interconnecting with a second body, the housing being provided with an inlet for receiving the end of the second body and the second body having a portion with an external diameter different from the remainder of the second body, and means for securing said second body end within said inlet, said securing means having at least one first securing member to engage the second body at said different external diameter portion thereby to secure said second body end within said inlet.

### FIELD OF THE INVENTION

This invention relates to the connection or termination of one body to another body. In principal each body may be any type of body and of any shape. The connections or terminations may also be to intermediate units which are themselves then connected to other systems.

### BACKGROUND OF THE INVENTION

Bodies are often connected together by means of a connector which is secured to both bodies. This is the case also if a body is to be terminated to another body. As an illustration, pipes are currently terminated into brake cylinder blocks, and other motor vehicle systems, by mean of connectors which are secured both to the pipe end and also to the other body, i.e. the motor vehicle system. It would be advantageous to be able to connect bodies together directly rather than via a connector. It would also be desirable that the termination be as simple as possible whilst providing a strong connection even under high pressure, and which is well sealed. It would also be desirable that the connection be robust. Other objects of the invention will be apparent from the following description.

### STATEMENT OF INVENTION

According to an aspect of the present invention there is provided an assembly having a first body including a housing for interconnecting with a second body, the housing being provided with an inlet for receiving the end of the second body and the second body having a portion with an external diameter different from the remainder of the second body, and means for securing said second body end within said inlet, said securing means having at least one first securing member to engage the second body at said different external diameter portion thereby to secure said second body end within said inlet.

In one embodiment, said at least one first securing member is deformable such that said first securing member deforms during insertion of the second body and at least partially reforms to a position in which said at least one securing member engages the second body at said different external diameter portion thereby to prevent relative longitudinal movement between said second body end and said first securing member.

In one embodiment, said at least one first securing member is deformable between a first position in which said at least one securing member engages the second body at said different external diameter portion and a position wherein the securing member undergoes longitudinal movement and/or radial movement.

The said at least one first securing member may comprise a sleeve for the second body. The said at least one first securing member may comprise a ring or split ring.

In one type of embodiment the at least one first securing member is radially deformable.

In another type of embodiment, said at least one first securing member is substantially non-deformable.

The first securing member may be circumferentially continuous or circumferentially discontinuous over at least that part of its length which is for engaging the second body, thereby allowing radial deformation of said first securing member. In that case, preferably the securing means is circunferentially discontinuous along its entire length thereby allowing radial deformation of said first securing member.

In one type of embodiment, the first securing member is in the form of at least two separate parts. The first securing member may, in particular, be in two or three parts. The parts may be movable with respect to each other. The parts themselves may be individually non-deforrnable.

An at least two part first securing member is advantageous, for example, for use with a smaller diameter second body where deformation of a continuous ring or split ring for example may be a problem.

The first securing member may be in the form of a washer or the like to engage a portion of enlarged external diameter in the second body. The washer may be retained in place by one or two second securing members. Where two securing members are used, one may be for engagement in the inlet and adjacent the washer and a further one may be for restricting removal of the first mentioned second securing member. The inner second securing member may be in the form of circlip and the outer second securing member may be in the form of a collar or cap.

Preferably, the securing means includes a second securing member for retaining the first securing member in engagement with the second body and thereby assisting locking the second body end within the inlet of the first body.

The second securing member may comprise, for example, a ring, collar or cap. Preferably the second securing member is in the form of a ring, collar or cap moveable longitudinally relative to the end of the second body in order to be located where it is able to hold the at least one first securing member in its second body engaging position. The second securing member is preferably substantially non-deformable, i.e. is substantially rigid.

The second securing member preferably is adapted to be positively retained in the first body in a position to hold the first securing member in its second body engaging position. The second securing member may be push fitted into place. The second securing member may be provided with at least one retaining lug, barb or the like to retain the second securing member in place. Alternatively, the second securing member may be provided with a screw thread and screwed into place. Alternatively or additionally, a circlip may be provided behind the second securing member to retain it in place. The circlip may be provided in outwardly biased form, retainable in a recess in the inlet behind the second securing member to retain the same. The circlip may be provided inwardly biased, retainable in a recess in the surface of the second body behind the second securing member.

The invention may be realised with different relative positions of the first securing member, second securing member and housing. For example, the second securing member may be located between the first securing member and the housing, or the first securing member may be located between the second securing member and the housing, or the housing may be located between the first securing member and the second securing member. In one embodiment the second securing member may fill the space in the inlet to prevent movement of the securing means and second body, thereby to prevent removal of the second body.

The said at least one first securing member may be located partly or wholly within the housing inlet or partly or wholly outside thereof. Where the first securing member is located partly or wholly within the housing inlet the fitting is less intrusive, has a sleeker appearance and has less chance of damage.

Where the said at least one first securing member is located in the housing inlet, the said at least one first securing member may be located in the housing inlet prior to insertion of the second body end. Alternatively, the said at least one first securing member may be inserted in the housing after or with the second body end.

In the type of embodiment where said at least one first securing member is deformable as aforesaid, the said at least one first securing member may be located in the housing inlet prior to insertion of the second body end. In the embodiment where said at least one first securing member is substantially non-deformable, said at least one first securing member may be inserted in the housing after or with the second body end.

Conveniently, where said at least one first securing member is inserted in the housing after or with the second body end, the at least one first securing member may be provided in at least two parts which can more easily be inserted in the housing inlet after or with the second body end.

The at least one first securing member and second securing member may comprise any suitable material. The material may include a resilient material. The material may include a resilient material, for example, where the securing member is deformable. Resilient materials may include rubber, elastomer or plastics materials. The material may include a metal, e.g. spring steel.

Preferably, the portion of the second body with an external diameter different from the remainder of the second body is circumferentially extending, but need not be, e.g. it may take the form of one or more portions on the second body with different external diameter. For the avoidance of doubt, the term diameter includes bodies where the cross section is other than circular. The portion of the second body with different external diameter may be located within the inlet or outside thereof. Preferably, where the first securing member is inside the first body then the portion of the second body with different external diameter is also inside. The portion of the second body end having an external diameter different from the remainder may take a number of different forms. Preferred forms include a groove (i.e. a portion of smaller external diameter), or an “upstage” or “upset” (i.e. a portion of enlarged external diameter). Another preferred embodiment includes an enlarged diameter end portion longitudinally extending to the open end of the second body to form e.g. a bell shape. The provision of a portion of enlarged external diameter has the advantage that the bore of the second body is not affected which makes the arrangement particularly suitable for small bore bodies.

Preferably, the assembly further includes sealing means to provide a seal between the housing and the second body. The sealing means may comprise an O ring. The assembly may further include means to hold the sealing means in position, e.g. a compression ring or washer.

The first body may be any body for retaining a second body and is, in principal, not limited. The first body may be an operating unit. For instance, the first body may be a vehicle system such as a brake cylinder block or air conditioning units, or it may be a junction box to which an electrical conduit is to be connected. Alternatively it may be an intermediate unit which is in turn connectable to another system, an example being a unit or connection for attachment of a high pressure hydraulic hose connector to a water stand pipe providing a supply of water to an hydraulic high pressure hose. The first body may thus be an adapter or connector which connects the second body in turn to a still further body.

The second body may, in principal, be any shape or have any cross-sectional profile. The second body may be hollow or solid. The second body may include, for instance, any tubular member, pipe, conduit or duct. Specific examples include pipes in hydraulic systems or conduits for electrical cables.

It can seen from the foregoing that the present invention is concerned with the provision of a female housing, where the housing forms part of a first body, e.g. an operative unit or being part of an intermediate unit for connection to another system. Moreover, preferably, the present invention is based on the provision of a housing provided with an inlet into which a second body may be inserted.

Advantageously, the invention permits a second body to be directly connected to a first body without need for a separate connector. The second body may be simply push fitted into the housing of the first body, thus not requiring complicated or time consuming assembly.

In one type of embodiment, the inlet preferably includes a reduced diameter mouth portion and an enlarged chamber extending therefrom. The portion of the second body end having its external diameter different from that of the remainder of the second body lies wholly or partly within the chamber. In one embodiment, the chamber is of sufficiently large diameter to accommodate a first securing member which is spring biased towards a condition in which it is relatively narrow diameter. For example, the securing member may comprise a split ring. The securing member is preferably located at least partly within the chamber and there is sufficient room, within the chamber, for the securing member to be expanded, preferably radially, as a result of the introduction of the second body within the securing member which is in turn located within the chamber. When the second body end is located fully into the inlet, the split ring is able to contract while remaining in engagement with the outer surfaces of the second body and preferably with a radial surface remaining in abutment with the radial surface of the chamber. The result is that the securing member traps the second body end within the inlet, the mouth of which may then be closed by means of an appropriate second securing member such as a ring, collar or cap thereby to restrict further movement of the first securing member.

In a further embodiment, where the inlet includes a reduced diameter mouth and an enlarged diameter chamber, and where the pipe end has its different external diameter portion located wholly or partly within the chamber, the at least one first securing member may be manoeuvred into the chamber after insertion of the second body end, thereby to engage the different external diameter portion thereof. The securing member may be substantially non-deformable in this case. The securing member may comprise an at least two part form, which parts thereof may be substantially rigid, which is manoeuvred, preferably one part at a time, into the chamber after insertion of the second body end. The mouth of the inlet may again be closed by an appropriate second securing member to hold the first securing member in place and prevent removal of the second body.

In a still further embodiment, the inlet may include a mouth portion substantially the same diameter as a chamber portion extending therefrom. In one such embodiment, the at least one first securing member, which preferably is substantially rigid, is put onto the second body end, in engagement with the different external diameter portion thereof, prior to insertion of the second body end into the inlet. The external diameter of the securing member when so engaged on the second body end is such that the member is in close abutment with the inlet wall, thereby keeping the securing member firmly in place about the second body end. An appropriate second securing member may then be employed to close the mouth of the inlet to hold the first securing member and second body in place in the inlet.

It will be appreciated that presently existing bodies may have inlets which include a threaded portion or some other means for securing another body therein. The invention may include an adapter having one threaded end, preferably externally threaded, for engagement with the threaded portion of a main body, or being otherwise adapted for engagement with the inlet of a main body, and the having the other end provided with an inlet for receiving the end of a second body, the second body having a portion with an external diameter different from the remainder of the second body, and means for securing said second body end within said inlet of the adapter, said securing means having at least one first securing member to engage the second body at said different external diameter portion thereby to secure said second body end within said inlet of the adapter. The adapter can be pre-fitted to the main body, e.g. via the screw thread, such that the second body, in use, when required, can be easily push fitted into the adapter inlet and thereby is connected to the main body without a complex and time consuming operation being required.

### BRIEF DESCRIPTION OF THE DRAWINGS

The present invention will be further described, by way of examples only, with reference to the accompanying drawings, in which:

FIG. 1 shows, in longitudinal section, a first embodiment in accordance with the present invention;

FIG. 2 shows, in longitudinal section, a second embodiment in accordance with the present invention together with two components shown in the perspective view;

FIG. 3 shows, in longitudinal section, a third embodiment of an assembly in accordance with the present invention with two components also shown in perspective view;

FIG. 4 shows, in longitudinal section, a fourth embodiment of assembly in accordance with the present invention;

FIG. 5 shows, in longitudinal section, a fifth embodiment of assembly according to the invention;

FIG. 6 shows in longitudinal section, a sixth embodiment of assembly according to the invention;

FIG. 7 shows in longitudinal section, a seventh embodiment of assembly according to the invention;

FIG. 8 shows in longitudinal section, an additional retention means for an assembly according to the invention;

FIG. 9 shows in longitudinal section, a further embodiment of assembly according to the invention;

FIG. 10 shows in longitudinal section, a further embodiment of assembly according to the invention;

FIG. 11 shows in longitudinal section, a further embodiment of assembly according to the invention;

FIG. 12 shows in end view and part cross-sectional view, an embodiment of retaining ring for an assembly according to the invention;

FIG. 13 shows in longitudinal section, a further embodiment of assembly according to the invention; and

FIG. 14 shows in longitudinal section and in separated form, a further embodiment of assembly according to the invention.

### DETAILED DESCRIPTION OF THE SPECIFIC EMBODIMENTS

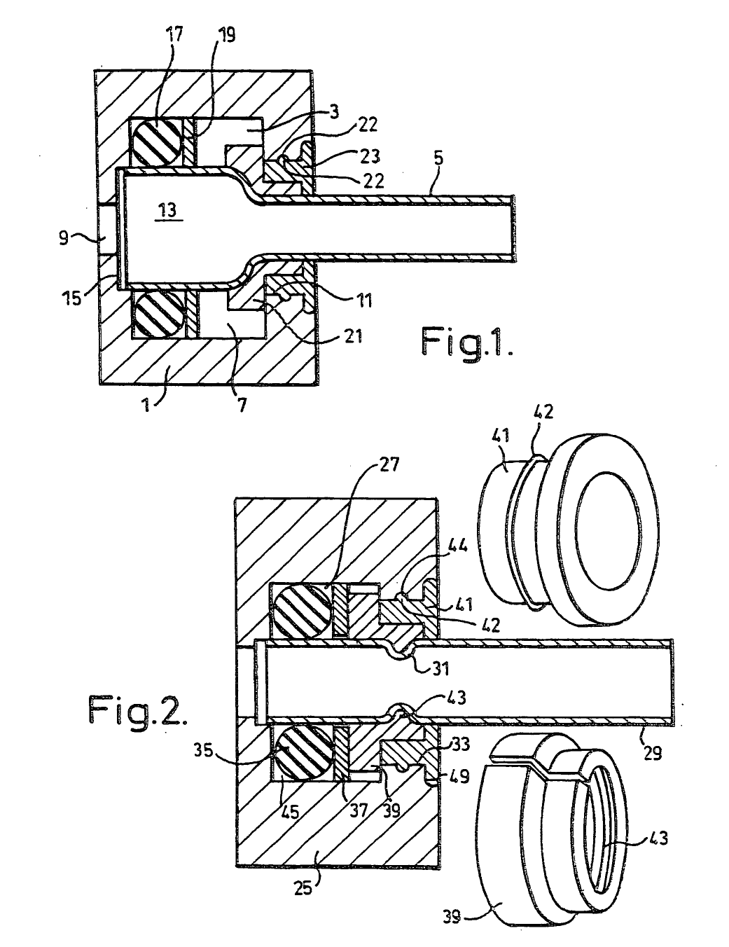

Referring to FIG. 1 of the accompanying drawings, a first embodiment of an assembly in accordance with the present invention includes part of a brake cylinder block 1 which includes an inlet 3 within which is located the end of pipe 5 thereby putting the interior of the pipe 5 in fluid flow connection with the brake cylinder block.

Inlet 3 includes an enlarged central portion 7 from which extends a fluid outlet 9 having a diameter approximately that of the internal diameter of the main body of pipe 5. Opposite outlet 9 is a profiled mouth portion 11 whose diameter adjacent main portion 7 is between that of main portion 7 and the external diameter of pipe 5. Adjacent the opening into block 1, portion 11 of inlet 3 is stepped outwardly as illustrated.

Located within inlet 3 of block 1 is the end of pipe 5 which is provided with an enlarged end 13 having a free end terminating inside enlarged portion 7 and close to a stepped portion 15 of inlet 3 adjacent outlet 9 which restricts inward movement of the pipe. Enlarged end portion 13 of pipe 5 narrows to the diameter of the main part of the pipe at a position at or adjacent to the inner end of mouth portion 11.

Within inlet 3 there are located, in addition to the end of pipe 5, a number of other items for effecting sealing and for holding the pipe end within inlet 3. For sealing purposes, there is provided an “O” ring 17 which bears against the outer surface of the enlarged portion 13 of pipe 5 and which also bears against internal surfaces of inlet 3, as illustrated. In addition there is provided a compression ring or washer 19 which holds the “O” ring in position.

The end of pipe 5 is held in position within the inlet 3 by means of a combination of a split ring 21 and a holding collar or cap 23. Ring 21, which is circumferentially discontinuous to allow it to be radially squeezed to reduce its diameter, is profiled to match the surface of pipe 5 where it opens out to enlarged portion 13 as well as for some distance along pipe 5 where it is of its normal, relatively narrow diameter. Externally ring 21 has a stepped configuration as shown. At its largest external diameter, corresponding to the region where the pipe 5 is curved, the diameter of the ring 21 is, in its normal condition, greater than that of the mouth 11 of inlet 3. However, when squeezed, ring 21 may be inserted through mouth 11 of inlet 3 into the position illustrated in FIG. 1 where it may be released to expand radially so as to be held within the large chamber 7 of inlet 3 and with external radial surfaces abutting internal radial surfaces of inlet 3, as illustrated. The pipe end may then be inserted into the block via mouth 11, during which movement the split ring 21 is forced outwardly until the position shown in the drawing is reached, when the ring contracts again.

Cap 23 is shaped to occupy the whole of the remainder of mouth 11 of inlet 3 once the split ring 21 is in place. As a result, the end of pipe is held firmly in place by ring 21 within inlet 3 and the external appearance of block 1 is simply of a smooth housing into which pipe 5 extends. The cap 23 is provided with circumferential retaining projection 22 which snaps into a corresponding recess 24 in the surface of mouth 11 to keep cap 23 positively retained in the inlet.

Referring to FIG. 2 of the accompanying drawings, a brake cylinder block 25, part of t which is shown in the drawing, is provided with a shaped inlet 27 for accommodating the end of a pipe 29 which in this case is provided with an inwardly extending circumferential groove 31 located a short distance from the very end of pipe 29. The remainder of the pipe 29 is of constant diameter.

As illustrated, at the end of pipe 29 located within inlet 27 extends from the mouth 33 of inlet 27 to the other end of inlet 27 where it terminates near a stepped radial surface of the inlet to restrict further inward axial movement.

Located within inlet 27 is an “O” ring 35, and a retaining washer 37 as well as a split ring 39 and a closing cap 41. Split ring 39 is of essentially L-shaped in cross section but is provided with an internal, inwardly directed ring 43 which is shaped and sized to match groove 31.

As in the case of the FIG. 1 embodiment, the inlet 27 includes relatively large diameter chamber 45 and a smaller diameter mouth portion 33, the latter being profiled to match the external shape of cap 41 including an enlarged entry portion 49.

As before, split ring 39 can be inserted into position by squeezing the ring radially, inserting it to the longitudinal position shown in FIG. 2 and then allowing it to expand so that its outer most part is located in abutting contact with the radial surface of chamber 45 adjacent mouth 33. The pipe end may then be inserted until the ring 43 occupies groove 31. Cap 41 can then be inserted into mouth 33 to close the inlet 27. Cap 41 has circumferential retaining projection 42 which locates in peripheral recess 44 of mouth 33.

Referring to FIG. 3 of the accompanying drawings, there is illustrated a block 51 for a brake cylinder only part of which is shown in the drawing. Block 51 is provided with an inlet 53 for the end of a pipe 55. In this case the pipe is provided with a circumferential enlargement or protrusion also variously referred to as an upstage or upset which protrudes radially outwardly from the body of the pipe and which is located a short distance from the very end of the pipe. As illustrated protrusion 57 lies within inlet 53 when the pipe is located in position with its end within block 51. In this position the end of pipe 55 extends through the mouth 59 of inlet 53 to the position illustrated where its end terminates near the stepped surface of inlet 53.

Also located within inlet 53 is an “O” ring 61 which provides sealing between the external surface of the pipe and the internal surfaces of inlet 53 of block 51. “O” ring 61 is maintained in position by means of ring 63.

Pipe 55 can be inserted into inlet 53 since the greatest diameter to the pipe, corresponding to protrusion 57, is less than the smallest diameter of mouth 59. The pipe end is then held in position by means of split ring 65 which is internally profiled to match the curved surface of protrusion 57 and the main body of pipe 55 in the direction from protrusion 57 towards the enlarged entry portion 67 of mouth 59. As illustrated in FIG. 3, radial surface at 69 of split ring 65 abuts inner radial surface 71 of the relatively large diameter chamber 73 of inlet 53. The mouth 59, including entry portion 67 may be closed by means of the cap 75. Cap 75 has a retaining projection 72 on its small diameter surface which slots into recess 74 in the surface of mouth 59.

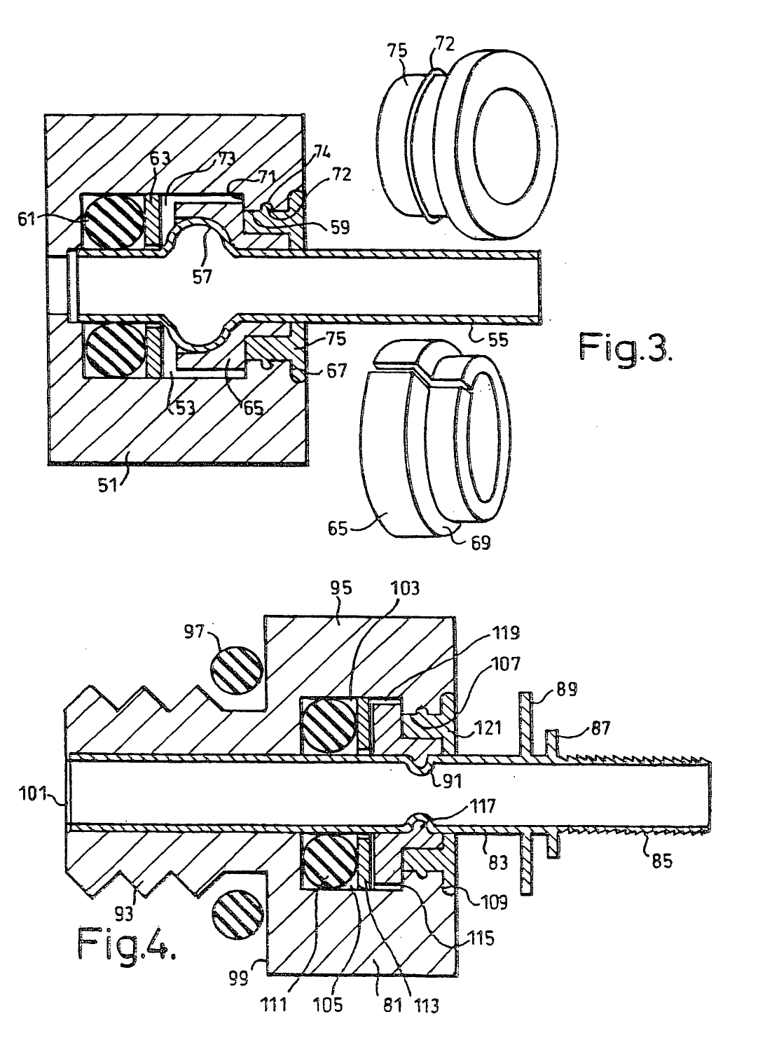

Referring to FIG. 4 of the accompanying drawings, there is illustrated a connector 81 for connecting an hydraulic hose fitting 83 to, for instance, a water stand pipe (not shown). The fitting 83 is in the form of a length of pipe having, at one end, a serrated portion 85 for location within a flexible hydraulic hose. Adjacent serrated portion 85 are two radial flanges 87 and 89 and spaced from these flanges in a direction away from serrated portion 85 is an internally directed, circumferential groove 91.

Connector 81 comprises a relatively small diameter portion 93 which is provided with an external screw thread for connection to, for instance, the stand pipe (not shown). Adjacent portion 93 is a relatively large diameter portion 95 and an “O” ring 97 is located around portion 93 next to adjacent radial surface 99 of large diameter portion 95. This “O” ring 97 provides sealing between the female connection of the stand pipe (not shown) and the connector 81.

A pipe accommodating bore extends centrally through connector 81. Within portion 93 the bore is of sufficient diameter just to accommodate fitting 83 which extends to a reduced diameter 101 where its end terminates adjacent the inner radial surface of this outlet 101. Within portion 95 of connector 81, the bore is enlarged to provide an inlet 103 having a main chamber 105 and a reduced diameter mouth portion 107 which itself is provided with an enlarged entry portion 109.

Located within chamber 105 is an “O” ring 111 which is held in position by means of ring 113 and provides sealing between the internal surface of connector 81 and the external surface of fitting 83.

Between ring 113 and mouth 107 is a split ring 115 which is similar to that illustrated in FIG. 2. It is substantially L-shaped in cross section and is provided with an internally directed rib 117 which is shaped to fit groove 91 of fitting 83, with the split ring in the position illustrated in FIG. 4, the end of pipe 83 may be introduced into the connector 81. While the pipe end is being inserted, the split ring is forced radially outwardly so that its outer diameter occupies the space 119 within chamber 105. When the groove 91 of pipe 83 reaches rib 117 of split ring 115, the split ring contracts to the position shown in FIG. 4 and is held in that position by the groove and by the abutting radial surfaces of the split ring and the chamber 105. The mouth 107 of inlet 103 may then be closed by means of cap 121 which is similar to that illustrated in perspective view in FIG. 2. Connector 81 could be pre-fitted to a device for instance the stand pipe, such that pipe 83 can be connected to the stand pipe easily by push fitting.

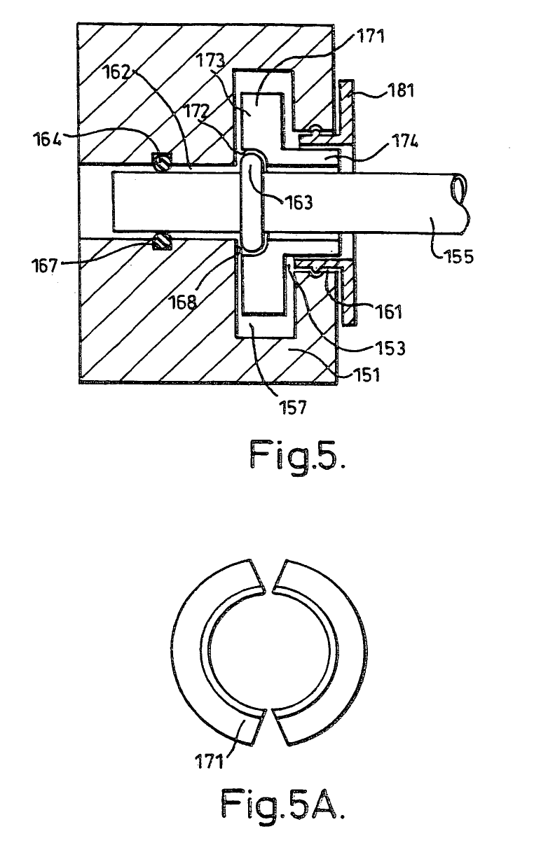

Referring to FIG. 5 there is shown a fifth embodiment of assembly according to the invention comprising a housing 151 forming part of an item of equipment, e.g. a brake cylinder. The housing 151 includes an inlet 153 within which is located the end of a hydraulic tube 155. The inlet 153 includes an enlarged diameter portion or chamber 157 and a smaller diameter mouth portion 161.

The very end of the tube 155 is located in a further portion 162 of the inlet 153. The portion 162 of the inlet 153 is of smaller diameter than the mouth portion 161. Within the portion 162 of the inlet is provided an O ring 167 which is located in a recess 164 in the radial surface of the inlet portion 162. The O ring 167 provides a radial seal between the inlet and the tube 155.

The tube 155 is provided with an upstage or protrusion 163 at a position distanced from the end of the tube 155. The upstage 163 is of larger external diameter than the inlet portion 162 but smaller than the diameter of the mouth portion 161 of the inlet.

The end of the tube 155 is inserted into the inlet 153 until the upstage 163 abuts against the radial wall 168 of the chamber 157. The end of the tube 155 is held in position in the inlet 153 by means of a two part retaining ring 171 and retaining cap 18 1. The retaining ring 171 is constructed of steel and is substantially rigid. It will be appreciated that it may be made of other materials, e.g. other metallic materials. The retaining ring 171 is made in two parts, or otherwise deformable, in order to fit the ring 171 within the inlet 153. The retaining ring 171 is also shown end-on in FIG. 5A which illustrates the two part nature of the ring. The retaining ring 171 is substantially L-shaped in cross section but has a cut-away portion 172 shaped to match the profile of the upstage 163 in the tube 155. After insertion of the tube 155 in the inlet 153 the two halves of the retaining ring 171 are then manoeuvred through the mouth portion 161 of the inlet and into the position shown in FIG. 5. The ring 171 has a radially extending portion 173 and a longitudinally extending portion 174 which extends for some distance along the tube 155. The radially extending portion 173 of the ring 171 extends into the enlarged diameter chamber 157 of the inlet 153.

After insertion of the ring 171, retaining cap 181, which is circumferentially continuous and substantially L-shaped in cross section, is inserted into the radial space between the surface of the longitudinal portion 174 of the ring 171 and the surface of the mouth portion 161 of the inlet as shown. As a result, the retaining ring 171 is held firmly in place and thereby the tube 155 is secured within the inlet. Cap 181 may be provided with retaining means similar to those shown in FIGS. 1-4 to positively retain the cap with the mouth 161 of the inlet.

The retaining cap 181 has an internal diameter greater than the diameter of the upstage 163 of the tube 155 which allows the retaining cap 181 to be slipped over the end of the tube 155 prior to insertion of the tube 155 into the inlet.

In an alternative embodiment to that shown in FIG. 5, the O ring seal 167 can be located in a holder at a position immediately adjacent the upstage 163 and between the upstage and the radial wall 168 of the enlarged chamber 157.

In a further alternative embodiment to that shown in FIG. 5, the tube 155 could be provided with a groove and ring 171 provided with a corresponding inwardly facing rib for engagement therewith.

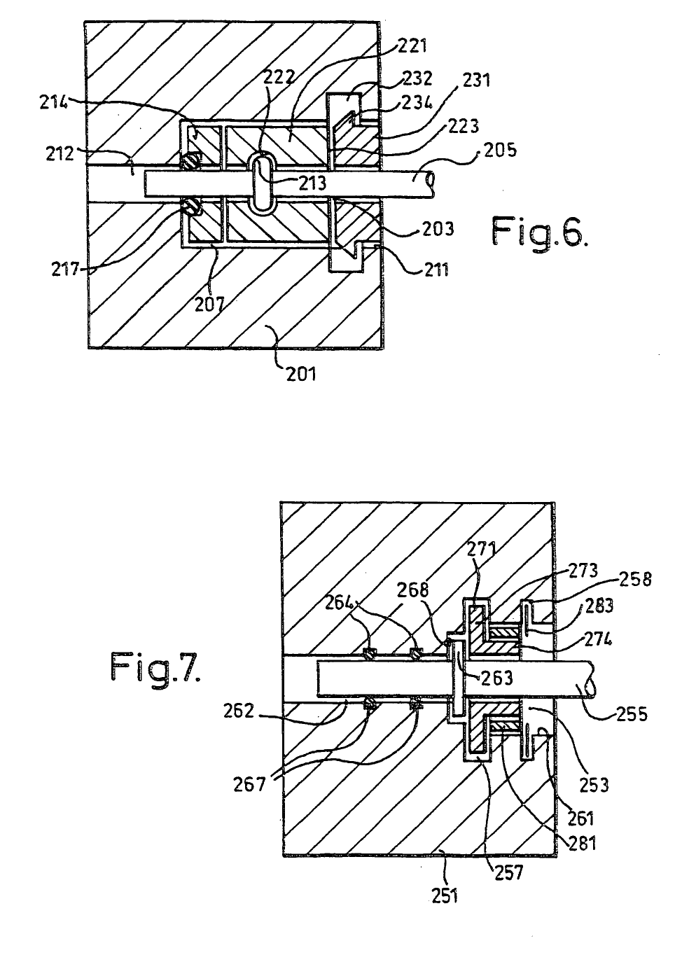

Referring to FIG. 6 there is shown a housing 201 (only part of which is shown). The housing may form part of any fitting or piece of equipment, e.g. a brake cylinder block. The housing 201 includes an inlet 203 within which is located the end of a tube 205.

The inlet 203 has a mouth portion 211 and a chamber portion 207 of the same diameter. The mouth portion 211 and the chamber portion 207 are longitudinally spaced by a portion 232 of larger diameter which forms a recess in the inlet.

The very end of the tube 205 is located within a smaller diameter portion 212 of the inlet. The surface of the inlet 203 is sealed to the surface of the tube 205 by means of O ring 217 which is held in place by circumferentially continuous collar 214.

The tube 205 is provided with an upstage 213 of enlarged external diameter which is positioned at a distance from the end of tube 205. The upstage 213 is engaged by split collar 221. The collar 221 is provided in two parts which may be fitted around the tube 205. The collar 221 is provided with a radial groove 222 extending circumferentially on its inner surface. The groove 222 engages the upstage 213 on the tube 205.

The two part retaining collar 221 is fitted onto the tube 205 such that the groove 222 of the collar 221 fits over the upstage 213 in the tube 205. Then tube 205 with the collar 221 thereon is inserted into the inlet 203 until the inner most end of the collar 221 abuts against the collar 214 holding the O ring 217. The outer most end 223 of the collar 221 lies substantially level with the inner most edge of the recess 232. The two parts of the collar 221 are held in engagement around the tube 205 by virtue of the radially outer surface of the collar 221 being in close abutment with the inner surface of the chamber 207.

To prevent withdrawal of the tube 205 from the inlet 203, a retaining ring 231 composed of plastics material is provided. Another suitable material may be spring steel. The inner diameter of the cap 231 is sufficient to enable the ring 231 to be slid over the upstage 213 on the tube 205. The retaining ring 231 is substantially ring shaped and has a circumferentially extending barb 234 upstanding from its radially outer surface as shown in FIG. 6.

The retaining ring 231 is inserted into the inlet 203 behind the collar 221. The ring 231 is resilient enough to be squeezed through the mouth 211 of the inlet. When the ring 231 has been pushed far enough through the mouth 211, the barb 234 on the ring 231 extends once again radially into the recess 232 thereby locking the ring 231 and collar 221 within the inlet and thereby firmly holding in place the tube 205.

In an alternative to FIG. 6, the collar 221 could be provided with a rib to engage a grooved tube.

Referring to FIG. 7, there is shown a housing 251 (only part of which shown). The housing 251 may form part of an operative unit, erg. a brake cylinder block or other motor vehicle system. The housing 251 includes a inlet 253 within which is located the end of a tube 255.

The inlet 253 includes two portions of larger diameter 257 and 258 which form recesses in the surface of the inlet.

The very end of the tube 255 is located within a smaller diameter portion 262 of the inlet 253. The inner surface of the inlet is sealed to the surface of the tube 255 by means of O rings 267, of which there are two, the O rings being located within recesses 264 in the surface of the inlet portion 262.

The tube 255 is provided with an upstage or collar 263 on its surface thereby presenting a portion with enlarged external diameter. The upstage 263 is positioned at a distance from the very end of the tube 255.

The tube 255 is inserted into the inlet 253 until the upstage 263 abuts against the radial stepped surface 268 of the inlet 253 as shown in the Figure.

The tube 255 is held in place by a two part retaining ring 271. The retaining ring 271 is provided in two parts in a similar manner to the retaining ring shown in FIG. 5A. The retaining ring 271 is substantially L-shaped in longitudinal cross section. The two parts of the retaining ring 271 are positioned in the inlet 253 behind the upstage 263 as shown in the Figure. The retaining ring 271 comprises a radially outwardly extending portion 273 which locates within the enlarged diameter portion 257 of the inlet 253 and a longitudinally extending portion 274 which extends a distance along the tube 255 as shown in the Figure. The radial space between the portion 274 of the ring 271 and the surface of the inlet 253 is occupied by inserting a circumferentially continuous collar 281. The collar 281 is retained in place by means of a circlip 283 which squeezes to fit it through the reduced diameter mouth portion 261 of the inlet 253 but then expands into the recess 258 in the inlet surface. The embodiment shown in FIG. 7 permits the tube 255 to be freely rotated within the housing 251.

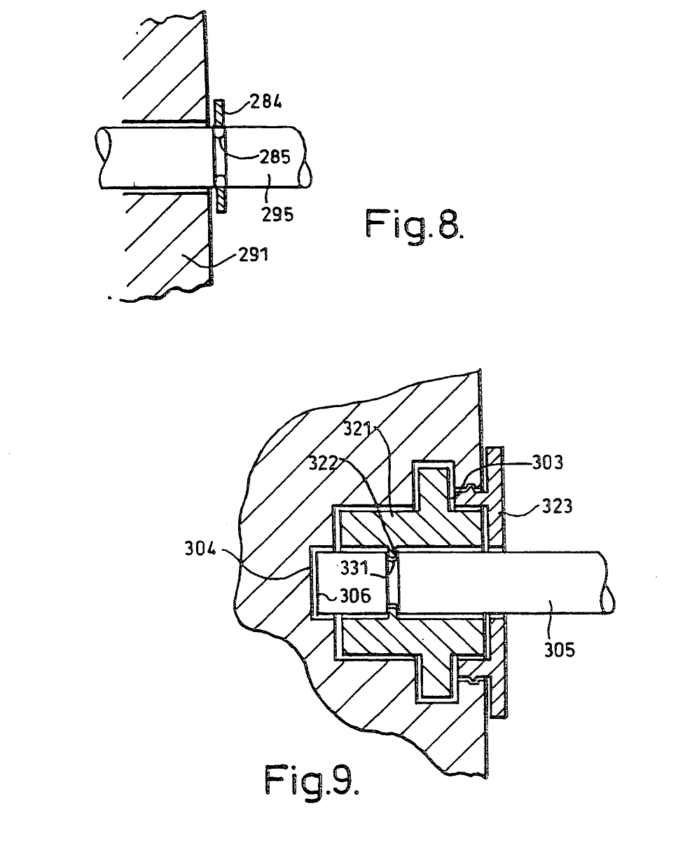

Alternatively, the collar 281 or some other collar may be retained in place, instead of circlip 283, by an inwardly biased circlip which grips a recess in the tube 255 behind the collar. Such an arrangement is shown schematically in FIG. 8, which shows such a circlip 284, adjacent part of a collar 291 to retain the same, the circlip 284 gripping a recess 285 in a tube 295. The detail of the rest of the assembly has been omitted from FIG. 8 for illustration purposes.

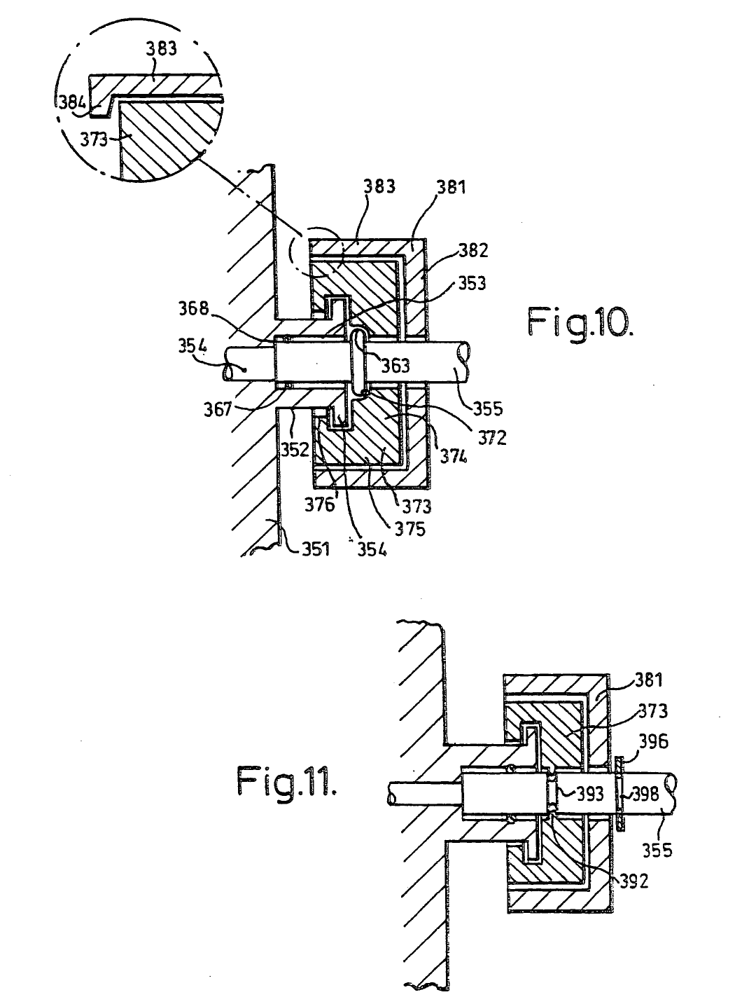

Referring to FIG. 9 there is shown a further embodiment of assembly according to the invention for the retention of a solid rod or beam 305. The assembly comprises a body 301 having an inlet 303 within which is located the end of the rod or beam 305. The assembly further comprises a two part retaining ring 321, which has an inwardly directed lug 322 for engaging in a circumferential groove 331 in the rod or beam 305. The remaining space in the inlet between the two part ring 321 and the surface of the inlet 303 is a retention cap 323 which holds two part ring 321 firmly in place thereby holding the end of rod or beam 305 in position in the inlet. It will be appreciated that no sealing means are required between the body 301 and the rod or beam 305 since there is no fluid connection involved. Moreover, the end 306 of rod or beam 305 terminates adjacent a surface 304 of the housing.

Referring to FIG. 10 there is shown a further embodiment of an assembly according to the present invention which comprises a housing 351 (only part of which is shown). The housing 351 includes an inlet 353 within which is located the end of a tube 355. In this embodiment, the inlet 353 is provided in a boss 352 raised from the surface of the housing 351. The boss 352 is provided with a flanged end 354. An ‘O’ ring 367 seals between the inlet 353 and the tube 355. The end of the tube 355 terminates near a radial surface 368 between the walls of the inlet 353 and a smaller diameter passage 354 extending from the inlet 353 into the housing.

The tube 355 is provided with a circumferentially extending upset 363 which is of larger diameter than the diameter of the inlet 353.

To hold the end of the tube 355 within the inlet 353 a deformable or split sleeve 373 is located around the tube 353 and has circumferential a cut away portion 372 to engage the upset 363 of the tube.

The deformable or split sleeve 373 comprises a radially directed part 374, a cylindrical wall 375 extending therefrom and an inwardly directed annular rib 376. The annular rib 376 of the sleeve 373 fits and locks over the flange 354 of the boss 352.

The deformable or split sleeve 374 is held firmly in the position shown in FIG. 10 by means of a retaining collar 381 to prevent expansion of the sleeve 373. The collar 381 has radially directed part 382 and a cylindrical wall 383 extending therefrom. To assist retention of the collar 381 on the sleeve 373, the end of the cylindrical wall 383 is provided with an inwardly directed annular rib 384 which fits and locks over the sleeve 373.

Referring to FIG. 11, there is shown a further embodiment of assembly according to the invention, similar to that shown in FIG. 10. In this case, the defornable or split sleeve 373 is provided with an inwardly directed lug 392 for engaging in a circumferential groove 393 in the tube 355. Furthermore, the retaining collar 381 is held in position on the deformable or split sleeve 373 by means of a circlip 396 behind the collar 381 which grips in a further groove 398 in the tube 355.

Referring to FIG. 12, there is shown an alternative embodiment of retaining ring or collar, i.e. ring for engagement with the different diameter portion of the tube etc. In this case, the ring comprises a continuous ring or collar 401 having thereon a plurality of radially inwardly facing tube engaging members 403, in this case four. Alternatively, the ring or collar 401 may be discontinuous. The number of members 403 may be varied. The members 403 may be integral with ring or collar 401 or attached thereto, e.g. welded thereto. The ring or collar in this embodiment is made of steel, but alternatively may be made of other material. The cross sectional shape of the members 403 is also shown in FIG. 12. It can be seen that the cross sectional shape of the members 403 is similar to that of the ring members in FIGS. 5 and 9 for example. The members 403 are substantially L-shaped in cross section, having a radial part 405 and a longitudinal part 407 extending therefrom. The longitudinal part 407 has a lug 408 for engaging in a groove in the tube etc. This embodiment of ring or collar has the advantage that it is in one-piece, as opposed to the two part ring construction shown in FIG. 5 for example, which makes it easier to handle. Further, it has advantages that, it may be made from a metal for strength, and by having a thinner outer ring or collar portion 401 with tube engaging portions 403 located only at certain points on the ring, it is resilient or springy enough to be radially deformable and so can be manoeuvred through a smaller diameter mouth of a housing inlet.

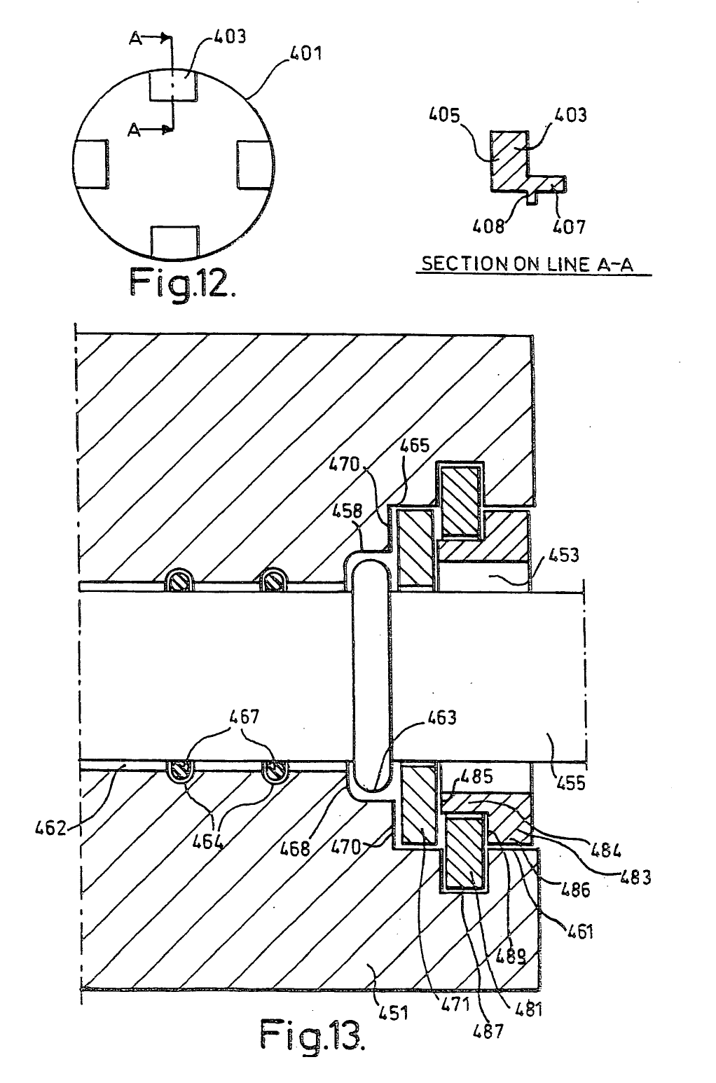

Referring to FIG. 13, there is shown a housing 451 (only part of which shown). The housing 451 may form part of an operative unit, e.g. a brake cylinder block or other. motor vehicle system. The housing 451 includes a inlet 453 within which is located the end of a tube 455.

The inlet 453 includes two portions of differing diameter 456 and 458 which are separated by step or radial surface 470 in the inlet.

The inner surface of the inlet is sealed to the surface of the tube 455 by means of O rings 467, of which there are two, the O rings being located within recesses 464 in the surface of narrower inlet portion 462.

The tube 455 is provided with an upstage or collar 463 on its surface thereby presenting a portion with enlarged external diameter. The upstage 463 is positioned at a distance from the very end of the tube 455. The tube 455 in use is inserted into the inlet 453 until the upstage 463 is restricted from further inward movement by radial stepped surface 468 of the inlet 453 as shown in the Figure.

The tube 455 is held in place by a retaining washer 471 as shown in the Figure. The washer 471 is retained in place by means of a circlip 481 which squeezes to fit it through the mouth portion 453. The circlip 481 then locates in recess 487 in the mouth 453 of the inlet in front of the washer 471 to retain the same. Further retention of the washer and circlip is provided by cap 483. Cap 483 is of generally L shape having a radially outwardly extending portion 486 which lies adjacent to surface 461 at the entrance to the inlet a surface 489 of which restricts movement of the circlip 481 in the direction out of the mouth and a longitudinally extending portion 484 the end 485 of which restricts movement of the washer 471 in the direction out of the mouth. It will be appreciated that in this embodiment it is relatively easy to match the washer to the upstage 463 on the tube 455. It will also be appreciated that two second securing members may be used in the invention, in this case being the circlip 481 and the cap 483.

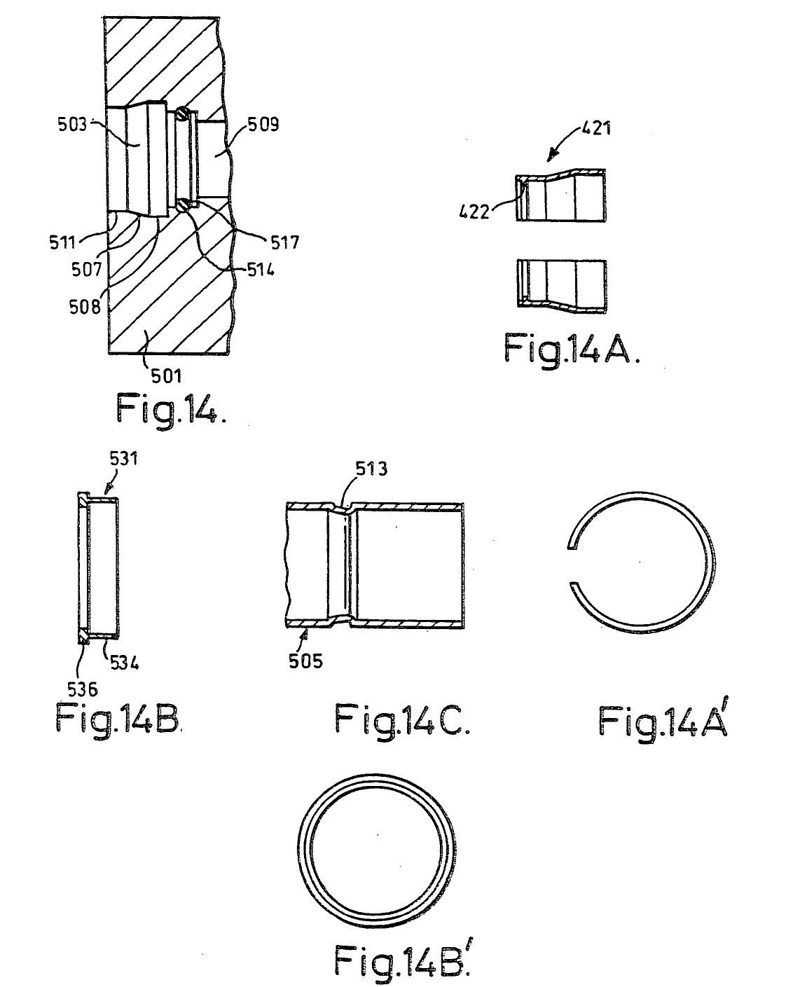

Referring to FIG. 14, an embodiment of an assembly in accordance with the present invention comprises a housing part of a brake cylinder block 501 which includes an inlet 503 for receiving the end of pipe 505 such that pipe 504 will be in fluid connection with the brake cylinder block.

Inlet 503 includes a mouth 511 whose diameter is greater than the external diameter of pipe 505 to an extent that mouth 511 provides an annular space around pipe 505 to accommodate split ring 421 and locking cap 531 as described below. Opposite mouth 511 is a fluid outlet 509 having a diameter slightly smaller than that of the external diameter of the pipe 505 which restricts inward movement of the pipe. Adjacent mouth 511 is a section 507 tapered outwardly in a direction away from the mouth 511 and extending from the tapered section 507 is a plain section 508 of larger diameter than mouth 511. Between section 508 and outlet 509 there is an section 514 profiled to accommodate an O ring 517 which in use bears against the outer surface of the pipe 505.

Located inside the inlet 503 in use and adjacent the surface thereof is split ring 421, shown in FIG. 14A (FIG. 14A′ shows an end view thereof). The split ring 421 is profiled as shown to match the sections 511, 507 and 508 of the inlet and dimensioned to have a close fit in the inlet, i.e. with its external radial surfaces abutting internal radial surfaces of inlet 503. The ring 421 is made of resilient material to allow the ring to be squeezed through the narrower diameter mouth portion 511. Projecting radially inwardly from ring 421 is rib 422 for location in use in groove 513 in the surface of pipe 505.

The end of pipe 505 will be held in position within the inlet 503 by means of the split ring 421 and a holding collar or cap 531. In use, the split ring 421 is inserted in the inlet 503 as described above. The pipe end 505 may then be inserted into the inlet via mouth 511, during which movement the split ring 421 is radially and axially compressed such that it is forced to some extent longitudinally inward into the inlet until the rib 422 snaps into groove 513 of the pipe 505 at which position the ring 421 may reform to its normal shape with rib 422 located in the groove 513.

To hold rib 422 of ring 421 in the groove firmly, a cap 531 is provided as shown in FIG. 14B (FIG. 14B′ in end view). The cap 421 is provided with longitudinal wall 534 for insertion in the inlet adjacent mouth section 511 in between the mouth surface and ring 421 thereby to keep the split ring 421 firmly in place with its rib 422 in the groove 513. The cap 531 snaps into the surface of mouth 511 to keep the cap positively retained in the inlet. The cap 531 is provided with circumferential projection 536 which remains outside the inlet for removal of the cap when needed.

It will be appreciated that variations to the foregoing embodiments of the invention can be made while still falling within the scope of the invention. Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

All of the features disclosed in this specification may be combined in any combination, except combinations where at least some of such features and/or steps are mutually exclusive.

It will be appreciated that many of the features described above, particularly of the preferred embodiments, are inventive in their own right and not just as part of an embodiment of the present invention. Independent protection may be sought for these features in addition to or alternative to any invention presently claimed. The features may therefore be used in connections of two bodies generally.

1. An assembly having a first body including a housing for interconnecting with a second body, the housing being provided with an inlet for receiying the end of the second body and the second body having a portion with an extmrnal diameter different from the remainder of the second body, and means for securing said second body end within said inlet, said securing means having at least one first secunng member to engage the second body at said different external diameter portion thereby to secure said second body end within said inlet characterised in that the first securing member is in the form of at least two separate parts.

2. An assembly as claimed in claim 1 wherein said at least one first securing member is deformable such that said first securing member de-forms during insertion of the second body and at least partially reforms to a position in which said at least one securing member engages the second body at said different external diameter portion thereby to prevent relative longitudinal movement between said second body end and said first securing member.

3. An assembly as claimed in claim 2 wherein said at least one first securing member is deformable between a first position in which said at least one securing member engages the second body at said different external diameter portion and a position wherein the securing member undergoes longitudinal movement and/or radial movement.

4. An assembly as claimed in any one preceding claim wherein said at least one first securing member comprises a sleeve for the second body.

5. An assembly as claimed in any one preceding claim wherein the at least one firt securing member is radially deformable.

6. An assembly as claimed in claim 5 wherein the first securing member is circumferentially discontinuous over at least that part of its length which is for engaging the second body, thcreby allowing radial deformation of said first securing member.

7. An assembly as claimed in claim 6 wherein the securing means is circumferentially discontinuous along its entire length.

8. An assembly as claimed in any one preceding claim wherein said at least one first securing member comprises a ring or split ring.

9. An assembly as claimed in any one preceding claim wherein said at least one first securing member is substantially non-deformable.

10. An assembly as claimed in any one preceding claim wherein the first securing member is in the form of a washer or the like to engage a portion of enlarged external diameter in the second body.

11. An assembly as claimed in any one preceding claim wherein the first securing member is in two or three parts.

12. An assembly as claimed in any one preceding claim wherein the said at least one first securing member is located partly or wholly within the housing inlet.

13. An assembly as claimed in claim 12 wherein the said at least one first securing member is located in the housing inlet prior to insertion of the second body end.

14. An assembly as claimed in claim 12 wherein the said at least one first securig member is inserted in the housing after or with the second body end.

15. An assembly as claimed in any one preceding claim wherein the said at least one first securing member is located partly or wholly outside the housing inlet.

16. An assembly as claimed in any one preceding claim wherein the securing means includes a second securing member for retaining the first securing member in engagement with the second body and thereby assisting locking the second body end within the inlet of the first body.

17. An assembly as claimed in claim 16 wherein the second securing member comprises a ring, collar or cap.

18. An assembly as claimed in claim 17 wherein the second securing member is moveable longitudinally relative to the end of the second body in order to be located where it is able to hold the at least one first securing member in its second body engaging position.

19. An assembly as claimed in any one of claims 16 to 18 wherein the second securing member is operative to be push fitted into place to retain the first securing member.

20. An assembly as claimed in any one of claims 16 to 19 wherein the second securing member is adapted to be positively retained in the first body in a position to hold the first securing member in its second body engaging position.

21. An assembly as claimed in claim 20 wherein the second securing member is provided with at least one retaining lug, barb or the like to retain the second securing member in the first body.

22. An assembly as claimed in claim 20 wherein the second securing member is provided with a screw thread to retain the second securing member in the first body.

23. An assembly as claimed in claim 20 wherein a circlip may be provided behind the second securing member to retain it in place.

24. An assembly as claimed in any one preceding claim wherein the second securing member is located between the first securing member and the housing.

25. An assembly as claimed in any one preceding claim wherein the first securing member is located between the second securing member and the housing.

26. An assembly as claimed in any one preceding claim wherein the housing is located between the first securing member and the second securing member.

27. An assembly as claimed in any one preceding claim wherein the second securing member fills the space in the inlet to prevent movement of the first securing member and second body, thereby to prevent removal of the second body.

28. An assembly as claimed in any one preceding claim wherein the at least one first securing member and/or second securing member comprises a resilient material

29. An assembly as claimed in claim 28 wherein the resilient material is selected from the group comprising rubber, elastomer or a plastics material.

30. An assembly as claimed in any one of claims 1 to 29 wherein the at least one first securing member and/or second securing member comprises a metal.

31. An assembly as clained in any one preceding claim wherein the portion of the second body with an external diameter different from the remainder of the second body is circumferentially extending.

32. An assembly as claimed in any one preceding claim wherein the portion of the second body with an external diameter different from the remainder of the second body comprises a groove.

33. An assembly as claimed in any one preceding claim wherein-the portion of the second body with an external diameter different from the remainder of the second body comprises a portion of enlarged external diameter.

34. An assembly as claimed in claim 33 wherein the portion of enlarged external diameter comprises an enlarged diameter end portion longitudinally extending to the open end of the second body.

35. An assembly as claimed in any one preceding claim wherein the assembly further includes sealing means to provide a seal between the housing and the second body.

36. An assembly as claimed in claim 35 wherein the sealing means comprises an O ring.

37. An assembly as claimed in any one preceding claim wherein the first body comprises an operating unit.

38. An assembly as claimed in any one preceding claim wherein the first body is an adapter or connector which connects the second body in turn to a still further body.

39. An assembly as claimed in any one preceding claim wherein the second body is hollow or solid.

40. An assembly as claimed in any one preceding claim wherein the second body comprises a tubular member, pipe, conduit or duct.

41. An assembly as claimed in any one preceding claim wherein the inlet includes a reduced diameter mouth portion and an enlarged chamber extending therefrom.

42. An assembly as claimed in claim 41 wherein the portion of the second body end having its external diameter different from that of the remainder of the second body lies wholly or partly within the enlarged chamber.

43. An assembly as claimed in claim 41 or 42 wherein the chamber is of sufficiently large diameter to accommodate a fist securing member which is spring biased towards a condition in which it is relatively narrow diameter.

44. An assembly as claimed in any one of claims 41 to 43 wherein the first securing member is located at least partly within the enlarged chamber and there is sufficient room, within the chamber, for the securing member to be expanded, preferably radially, as a result of the introduction of the second body within the securing member.

45. An assembly as claimed in any one of claims 41 to 44 wherein in use the second body end is located fully into the inlet and the first securing member is able to contract while remaining in engagement with the outer surfaces of the second body.

46. An assembly as claimed in any one of claims 41 to 45 wherein the mouth of the inlet is closed by means of a second securing member such as a ring, collar or cap thereby to restrict firer movement of the first securing member.

47. An assembly as claimed in any one preceding claim wherein the inlet includes a reduced diameter mouth and an enlarged diameter chamber, and the second-body end has its different external diameter portion located wholly or partly within the chamber, and the at least one first securing member is manoeuvred into the chamber after insertion of the second body end, thereby to engage the different external diameter portion thereof.

48. An assembly as claimed in claim 47 wherein the first securing member comprises an at least two part form which is manoeuvred into the chamber after insertion of the second body end.

49. An assembly as claimed in claim 48 wherein the mouth of the inlet is closed by a second securing member to hold the first securing member in place and prevent removal of the second body.

50. An assembly as claimed in any one preceding claim wherein the inlet includes a mouth portion substantially the same diameter as a chamber portion extending therefrom.

51. An assembly as claimed in claim 50 wherein the at least one first securing member is put onto the second body end, in engagement with the different external diameter portion thereof, prior to insertion of the second body end into the inlet.

52. An assembly as claimed in claim 51 wherein the external diameter of the first securing member when so engaged on the second body end is such that the member is in close abutment with the inlet wall, thereby keeping the securing member firmly in place about the second body end.

53. An assembly as claimed in claim 52 wherein a second securing member is employed to close the mouth of the inlet to hold the first securing member and second body in place in the inlet.

54. An assembly as claimed in any one preceding claim wherein the first body is an adapter having one end provided with the inlet for receiving the end of the second body and the other end is threaded, preferably externally threaded, for engagement with the threaded portion of another body, or being otherwise adapted for engagement with the inlet of another body.
